(19) United States
(12) Patent Application Publication
(10) Pub. No.: US 2010/0106346 A1
(43) Pub. Date: Apr. 29, 2010

(54) METHOD AND SYSTEM FOR MANAGING FLIGHT PLAN DATA

(75) Inventors: Harsh Badli, Bangalore (IN); Rupak Ghosh, Bangalore (IN)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/256,990

(22) Filed: Oct. 23, 2008

(51) Int. Cl. G06F 17/00; G01C 21/00

(52) U.S. Cl. 701/3; 701/213; 701/200

(57) ABSTRACT

Method and systems for managing flight plan data associated with an aircraft are provided. A list of navigational entry selections (e.g., flight plan origins and flight plan destinations) is generated. Each of the navigational entry selections is associated with the aircraft (e.g., previously used). The list of navigational entry selections is displayed to a user of the aircraft. An indication of a selection of at least one of the navigational entry selections is received from the user. The navigational entry selections are generated, for example, based on navigational entries previously stored in a memory on-board the aircraft, a location of the aircraft, or a combination of the previous navigational entries and the location of the aircraft.

### TECHNICAL FIELD

The present invention generally relates to avionics systems, and more particularly relates to a method and system for managing flight plan data.

### BACKGROUND

In recent years, the display devices used in vehicles, such as aircraft flight displays, have become increasingly advanced. Along with the technological advances, the amount of information displayed has increased, resulting in a similar increase in the amount of visual information to be perceived and understood by the user. In many situations, it is important that visual displays provide a proper cognitive mapping between the task that the operator is performing and the information available to accomplish the task. As a result, such systems increasingly utilize human-factor design principles in order to build instrumentation and controls that work cooperatively with human operators as efficiently as possible.

However, one of the subsystems that has not seen significant improvement in this regard is the flight management system (FMS). Specifically, in convention avionics systems, flight plan entry and editing is performed using cumbersome, manual-entry text-based techniques. As a result, current flight management systems are unsatisfactory.

Accordingly, it is desirable to provide a method and system for facilitating the entry of information into an avionics system (e.g., a FMS). Furthermore, other desirable features and characteristics of the present invention will become apparent from the subsequent detailed description and the appended claims, taken in conjunction with the accompanying drawings and the foregoing technical field and background.

### BRIEF SUMMARY

A method for managing flight plan data associated with an aircraft is provided. A list of navigational entry selections is generated. Each of the navigational entries is associated with the aircraft. The list of navigational entry selections is displayed to a user of the aircraft. An indication of a selection of at least one of the navigational entry selections is received from the user.

An avionics system is provided. The avionics system includes a display device, a user input device in operable communication with the display device and configured to receive manual inputs from a user, a memory device in operable communication with the display device and the user input device, the memory device being configured to store previous navigational entries associated with an aircraft, and a processor in operable communication with the display device, the user input device, and the memory device. The processor is configured to generate a list of navigational entry selections based on the previous navigational entries and a location of an aircraft, display the list of navigational entry selections on the display device, and select at least one of the navigational entry selections based on manual input received by the user input device.

A method for managing flight plan data associated with an aircraft is provided. Flight plan data is stored in a memory device on-board the aircraft. The stored flight plan data is transferred to a ground based computing system. An analysis is performed on the flight plan data with the ground based computing system.

### BRIEF DESCRIPTION OF THE DRAWINGS

The present invention will hereinafter be described in conjunction with the following drawing figures, wherein like numerals denote like elements, and

FIG. 1 is a block diagram schematically illustrating an aircraft according to one embodiment of the present invention;

FIG. 2 is a plan view of a flight plan entry window that is displayed on a display device on-board the aircraft of FIG. 1;

FIGS. 3-5 are plan views of an origin entry window illustrating the selection of various origins displayed therein;

FIG. 6 is a plan view of the flight plan entry window of FIG. 2;

FIG. 7 is a plan view of a destination entry window;

FIGS. 8-11 are plan views of a flight plan index window illustrating the selection of various flight plans displayed therein;

FIG. 12 is a plan view of a flight management system (FMS) unit displaying multiple flight plans in accordance with one embodiment of the present invention;

FIG. 13 is a plan view of a flight plan report page; and

FIGS. 14 and 15 are flow charts of methods for generating lists of navigational entries according to one embodiment of the present invention.

### DETAILED DESCRIPTION

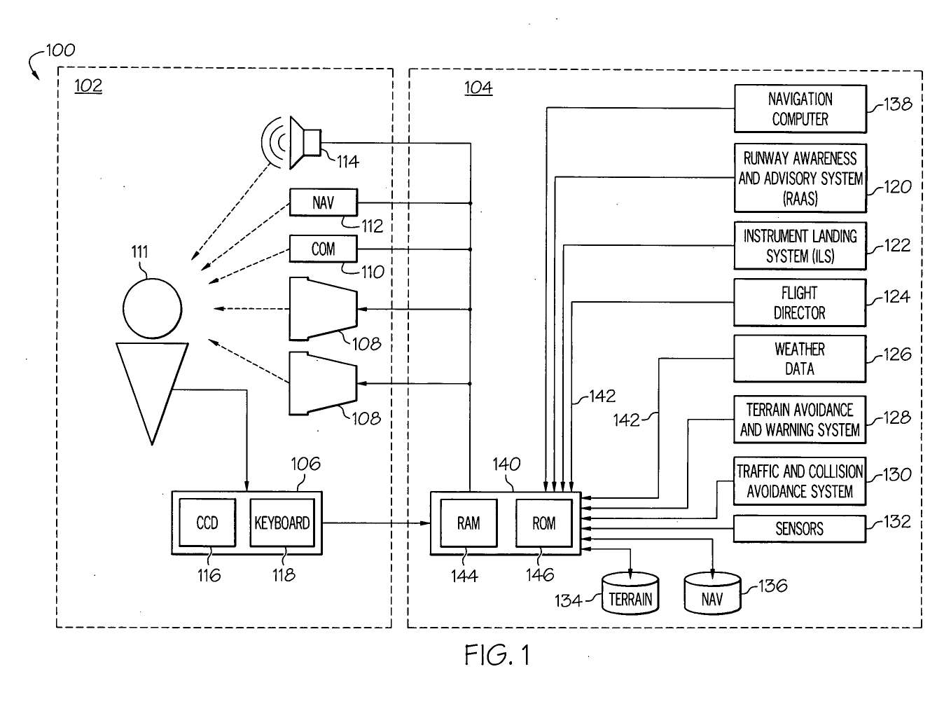

The following detailed description is merely exemplary in nature and is not intended to limit the invention or the application and uses of the invention. Furthermore, there is no intention to be bound by any expressed or implied theory presented in the preceding technical field, background, and brief summary or the following detailed description. It should also be noted that FIGS. 1-15 are merely illustrative and may not be drawn to scale.

FIG. 1 to FIG. 15 illustrate a method and system for managing flight plan data associated with an aircraft. A list of navigational entry selections (e.g., flight plan origins and flight plan destinations) is generated. Each of the navigational entry selections is associated with the aircraft (e.g., previously used). The list of navigational entry selections is displayed to a user of the aircraft. An indication of a selection of at least one of the navigational entry selections is received from the user. The navigational entry selections are generated, for example, based on navigational entries previously stored in a memory on-board the aircraft, a location of the aircraft, or a combination of the previous navigational entries and the location of the aircraft.

Methods and systems in accordance with various aspects of the present invention provide an improved interface for displaying and editing flight plan data. In this regard, the present invention may be described herein in terms of functional block components and various processing steps. It should be appreciated that such functional blocks may be realized by any number of hardware, firmware, and/or software components configured to perform the specified functions.

For example, the present invention may employ various integrated circuit components, such as memory elements, digital signal processing elements, look-up tables, databases, and the like, which may carry out a variety of functions under the control of one or more microprocessors or other control devices. Such general techniques and components that are known to those skilled in the art are not described in detail herein.

It should further be understood that the exemplary process or processes illustrated may include more or less steps or may be performed in the context of a larger processing scheme. Furthermore, the various flowcharts presented in the drawing figures are not to be construed as limiting the order in which the individual process steps may be performed.

FIG. 1 schematically illustrates a vehicle 100, such as an aircraft, in which the method and system described below may be implemented, according to one embodiment of the present invention. The vehicle 100 may be, in one embodiment, any one of a number of different types of aircraft such as, for example, a private propeller or jet engine driven airplane, a commercial jet liner, or a helicopter. In the depicted embodiment, the vehicle 100 includes a flight deck 102 (or cockpit) and an avionics/flight system 104. Although not specifically illustrated, it should be understood that the vehicle 100 also includes a frame or body to which the flight deck 102 and the avionics/flight system 104 are connected, as is commonly understood. It should also be noted that vehicle 100 is merely exemplary and could be implemented without one or more of the depicted components, systems, and data sources. It will additionally be appreciated that the vehicle 100 could be implemented with one or more additional components, systems, or data sources.

As shown in FIG. 1, the flight deck 102 includes a user interface 106, display devices 108 (e.g., a display screen for a flight management system (FMS) and a primary flight display (PFD)), a communications radio 110, a navigational radio 112, and an audio device 114. The user interface 106 is configured to receive manual input from a user 111 (e.g., a pilot or an operator) and, in response to the user input, supply command signals to the avionics/flight system 104. The user interface 106 may be any one, or combination, of various known user interface/text entry devices including, but not limited to, a cursor control device (CCD), such as a mouse, a trackball, or joystick, and/or a keyboard, one or more buttons, switches, or knobs. As such, the user interface 106 includes a text entry device comprising any device suitable to accept alphanumeric character input from user 111 and convert that input to alphanumeric text on the displays 108.

In the depicted embodiment, the user interface 106 includes a CCD 116 and a keyboard 118. The user 111 uses the CCD 116 to, among other things, move a cursor symbol on the display devices 108, and may use the keyboard 118 to, among other things, input textual data.

Still referring to FIG. 1, the display devices 108 are used to display various images and data, in graphic, iconic, and/or textual formats, and to supply visual feedback to the user 111 in response to user input commands supplied by the user 111 to the user interface 106. One or more of the displays 108 may further be a control display unit (CDU), a multifunction control display unit (MCDU), or a graphical display, and further may include information such as textual identifiers associated with the aircraft's regional airways, waypoints and procedures as determined from navigational data sources (as described below). Through use of the user interface 106, user 111 may modify the flight-plan and/or other such indicia graphically in accordance with visual feedback provided by the display devices 108.

The communication radio 110 is used, as is commonly understood, to communicate with entities outside the vehicle 100, such as air-traffic controllers and pilots of other aircraft. The navigational radio 112 is used to receive from outside sources and communicate to the user various types of information regarding the location of the vehicle, such as Global Positioning Satellite (GPS) system and Automatic Direction Finder (ADF) (as described below). The audio device 114 is, in one embodiment, an audio speaker mounted within the flight deck 102.

The avionics/flight system 104 includes a runway awareness and advisory system (RAAS) 120, an instrument landing system (ILS) 122, a flight director 124, a weather data source 126, a terrain avoidance warning system (TAWS) 128, a traffic and collision avoidance system (TCAS) 130, a plurality of sensors 132, one or more terrain databases 134, one or more navigation databases 136, a navigation and control system 138, and a processor 140. The various components of the avionics/flight system 104 are in operable communication via a data bus 142 (or avionics bus).

The RAAS 120 provides improved situational awareness to help lower the probability of runway incursions by providing timely aural advisories to the flight crew during taxi, takeoff, final approach, landing and rollout. The ILS 122 is a radio navigation system that provides aircraft with horizontal and vertical guidance just before and during landing and, at certain fixed points, indicates the distance to the reference point of landing. The flight director 124, as is generally known, supplies command data representative of commands for piloting the aircraft in response to flight crew entered data, or various inertial and avionics data received from external systems. The weather data source 126 provides data representative of at least the location and type of various weather cells. The TAWS 128 supplies data representative of the location of terrain that may be a threat to the aircraft, and the TCAS 130 supplies data representative of other aircraft in the vicinity, which may include, for example, speed, direction, altitude, and altitude trend. Although not illustrated, the sensors 132 may include, for example, a barometric pressure sensor, a thermometer, and a wind speed sensor.

The terrain databases 134 include various types of data representative of the terrain over which the aircraft may fly. The navigation (and/or avionics) databases 136 include various types of data required by the system, for example, state of the aircraft data, flight plan data, data related to airways, waypoints and associated procedures (including arrival and approach procedures) navigational aids (Navaid), symbol textures, navigational data, obstructions, font textures, taxi registration, special use airspace, political boundaries, communication frequencies (en route and airports), approach info, and the like.

Although not illustrated, the navigation and control system 138 may include a flight management system (FMS), a control display unit (CDU), an autopilot or automated guidance system, multiple flight control surfaces (e.g., ailerons, elevators, and a rudder), an Air Data Computer (ADC), an altimeter, an Air Data System (ADS), a Global Positioning Satellite (GPS) system, an automatic direction finder (ADF), a compass, at least one engine, and gear (i.e., landing gear). The processor 140 may be any one of numerous known general-purpose microprocessors or an application specific processor that operates in response to program instructions. In the depicted embodiment, the processor 140 includes on-board random access memory (RAM) 144 and on-board read only memory (ROM) 146. The program instructions that control the processor 140 may be stored in either or both the RAM 144 and the ROM 146. For example, the operating system software may be stored in the ROM 146, whereas various operating mode software routines and various operational parameters may be stored in the RAM 144. It will be appreciated that this is merely exemplary of one scheme for storing operating system software and software routines, and that various other storage schemes may be implemented. It will also be appreciated that the processor 140 may be implemented using various other circuits, not just a programmable processor. For example, digital logic circuits and analog signal processing circuits could also be used.

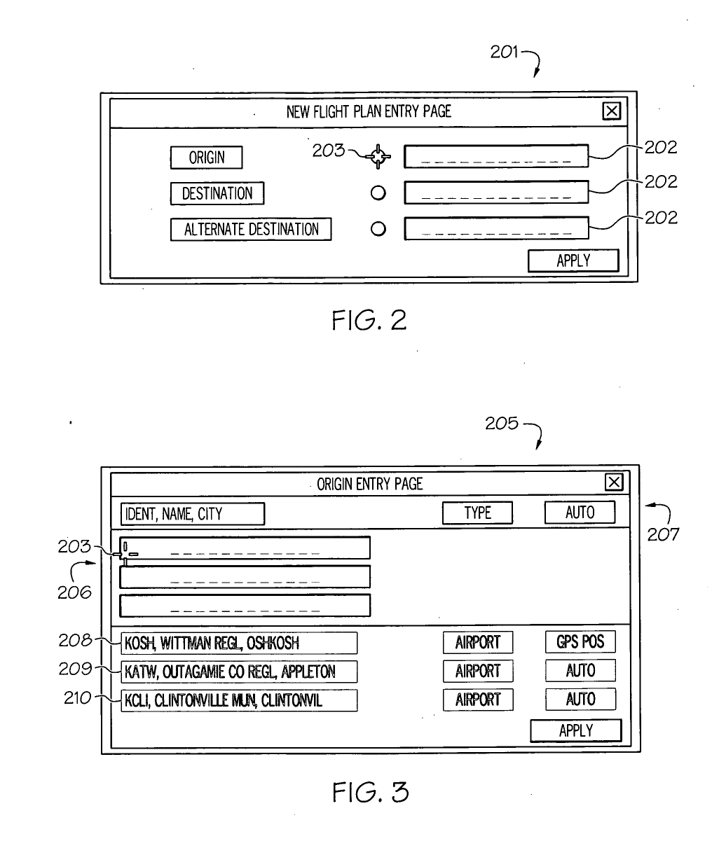

One embodiment of the present invention is illustrated in FIGS. 2-5. In this embodiment, as per the various aspects of the present invention, the operator (e.g., the user 111) is provided with methods to enter the source (or origin) identifier for the flight plan. Particularly referring to FIG. 2, an exemplary flight plan entry page (or window) 201 is illustrated. The operator is provided with text entry fields (or boxes) 202, such as “ORIGIN,” “DESTINATION,” and “ALTERNATE DESTINATION” entry fields 202. The various text entry fields are selected via a navigation cursor 203 that is operated or navigated by the user 111 with, for example, the CCD 116. As shown in FIG. 1, the text boxes 202 are filled with dashes indicating the user 111 has not yet entered the text data into the entry fields. The cursor 203 is used to select one of the text boxes 202 (e.g., the ORIGIN text box.)

FIG. 3 illustrates an origin entry page 205 that may be displayed to the operator after selecting the ORIGIN text box 202 in the flight plan entry page 201 of FIG. 2. According to one aspect of present invention, on the origin entry page 205, the operator is provided with origin text boxes 206, a specialized (or frequent) access list (or navigational entry selections) including stored origins 208, 209, and 210, and classification fields 207 to indicate the type and origin of each of the items in the specialized access list. In one embodiment, the list of items 208, 209, and 210 in the specialized access list is based on characteristics of the particular aircraft in which the system is installed (i.e., the list is unique to the aircraft). The characteristics of the aircraft that are used may be previous flight plan data entered into (or used) by the system or a position of the aircraft, as determined by the GPS system. That is, in the example depicted in FIG. 1, the specialized access list items 208, 209, and 210 include origins that had previous been used by the system (e.g., items 209 and 210) and an origin that is listed because it is within a particular proximity of the aircraft (e.g., item 208).

As such, the specialized access list may be generated using the aircraft's current position (e.g., FMS or GPS position), the aircraft's last known FMS position, one or more FMS database entries which were used recently, and one or more FMS database entries which have been accessed frequently. The list may also be dynamically modified based on a combination of frequent access identifiers and geographically proximity.

It should also be understood that the list may be constructed, in part or completely, with user defined or selected entries from the FMS database. That is, the operator may choose to define certain identifiers in his specialized access list, which shall then be displayed to the operator while entry of the fields. In the exemplary embodiment shown in FIGS. 3-5, the options displayed in the specialized access list are based on previous flight plan data stored in the FMS database (i.e., the navigational database 136) and the current FMS position.

The operator may then select one of the items from the specialized access list using the cursor 203. It should be noted this feature may eliminate the need for any manual text entry, except when the specialized access list does not include the desired flight plan data. Often a user accesses a limited set of complete identifiers. As such, embodiments of the present invention may utilize memory caching where most recently accessed data is stored in a special, fast access memory for easy retrieval based on the fact that recently used data may be used again in the near future.

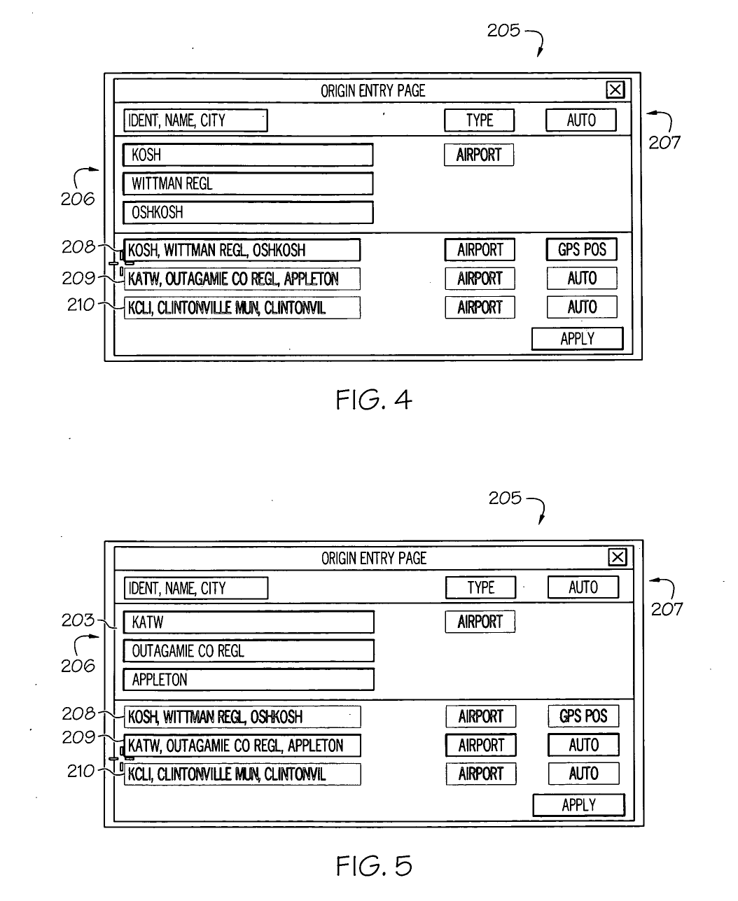

FIG. 4 illustrates the origin entry page 205 after the operator has selected origin entry 208 (KOSH) from the specialized access list. The origin text entry fields 206 are populated with the information associated with item 208 from the specialized access list (e.g., KOSH, WITTMAN REGL, OSHKOSH). As shown, the auto field 207 for the selected entry depicts the type of listing as GPS POS, which indicates that the specialized access list entry 208 is derived from GPS position.

FIG. 5 illustrates the origin entry page 205 after the operator has selected origin entry 209 (KATW) from the specialized access list. The origin text entry fields 206 are populated with the information associated with item 209 from the specialized access list (e.g., KATW, OUTAGAMIE CO REGL, APPLETON). As shown, the auto field 207 for the selected entry depicts the type of listing as AUTO, which indicates that the specialized access list entry 209 is derived from previous flight plan data.

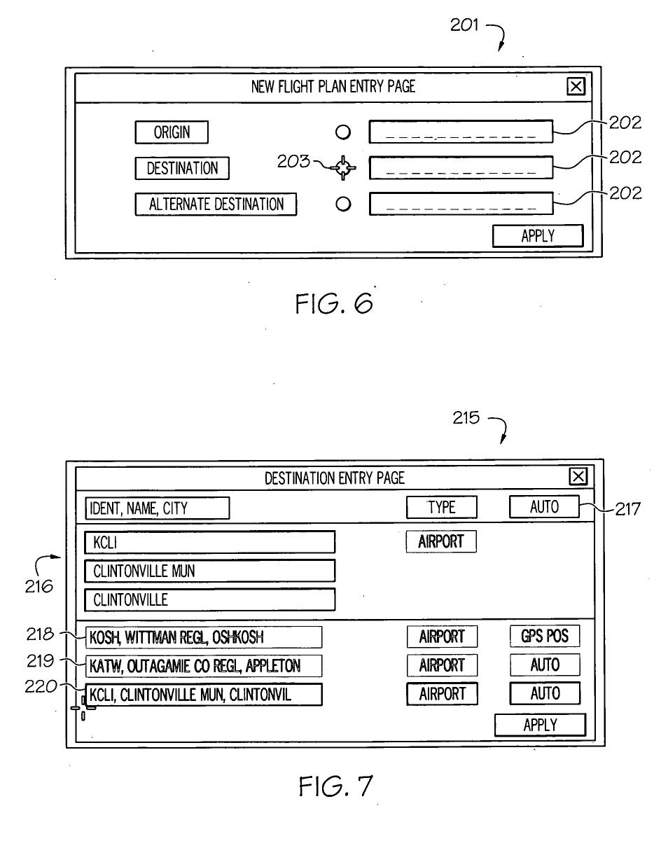

FIGS. 6 and 7 illustrate the selection of a destination identifier, according to one aspect of an embodiment of the present invention. As shown in FIG. 6, the operator uses the cursor 203 to selected the DESTINATION text box 202 in the flight plan entry page 201. FIG. 7 illustrates a destination entry page 215 that may be displayed to the operator after selecting the DESTINATION text box 202 in the flight plan entry page 201. According to one aspect of present invention, on the destination entry page 215, the operator is provided with destination text boxes 216, a specialized (or frequent) access list including stored destinations 218, 219, and 220, and classification fields 217 to indicate the type and origin of each of the items in the specialized access list. In a manner similar to that described above, in one embodiment, the list of items 218, 219, and 220 in the specialized access list is based on characteristics of the particular aircraft in which the system is installed (i.e., the list is unique to the aircraft). The characteristics of the aircraft that are used may be previous flight plan data entered into (or used) by the system or a position of the aircraft, as determined by the GPS system. That is, in the example depicted in FIG. 1, the specialized access list items 218, 219, and 220 include destinations that had previous been used by the system (e.g., items 219 and 220) and a destination that is listed because it is within a particular proximity of the aircraft (e.g., item 218).

As the destination entry page 215 is shown in FIG. 7, the operator has already selected (e.g., using the cursor 203) destination entry 220 (KCLI) from the specialized access list. The destination text entry fields 216 are populated with the information associated with item 220 from the specialized access list (e.g., KCLI, CLINTONVILLE MUNI, CLINTONVIL). As shown, the auto field 217 for the selected entry depicts the type of listing as AUTO, which indicates that the specialized access list entry 220 is derived from previous FMS data used by the system.

FIGS. 8-11 illustrate another aspect, or embodiment, of the present invention. Referring specifically to FIG. 8, a flight plan index page 401 is displayed to the operator. The flight plan index page 401 includes a listing of custom flight plans 405 that have been previously stored in the system, in which identifiers KAAA, KBBB, KCCC and KDDD are used as conceptual examples. In the example shown, the custom flight plans 405 are displayed in alphabetical order. A scroll bar 408 is provided to navigate (e.g., via the cursor 203) through the list of custom flight plans 408. A specialized access list 404 is displayed in the flight plan index page that includes, for example, frequently used flight plans. The specialized access list 404 may be generated in a manner similar to those described above. That is, the list of flight plans is customized for the particular aircraft in which the system is utilized (e.g., using frequently used flight plans or the most recently generated flight plan).

In one embodiment, the operator is provided with a method to sort or prioritize the flight plans shown in the specialized access list 404. In the depicted embodiment, sorting buttons 407 are provided that allow the operator to sort the flight plans based distance, time and fuel requirements. As is commonly understood, each of the flight plans displayed on the flight plan index page 401 suitably changed using function buttons 406 (i.e., EDIT/VIEW, DELETE, and ENTER).

The specialized access list 404 and/or the custom flight plan list 405 may be additionally sorted by entering an origin and/or destination into respective origin 402 and/or destination 403 text boxes. In one embodiment, the entry of the origin and/or destination is performed using the methods described above.

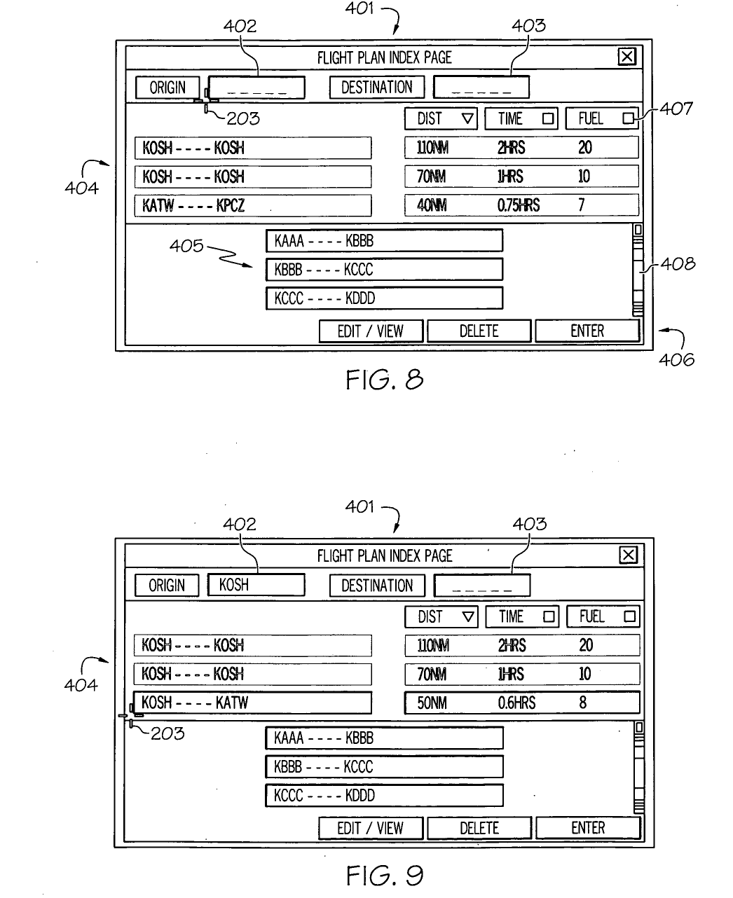

FIG. 9 illustrates the flight plan index page 401 after the operator has specified an origin (KOSH) in the origin text box 402, while the destination text box 403 remains unoccupied. Of particular interest is that the specialized access list 404 now includes only flight plans that originate from KOSH. The operator may then select a flight plan from the specialized access list 404 (or the custom flight plan list 405) as the active flight plan using the cursor 203 (and/or the ENTER function button). In the example shown in FIG. 9, the operator is selecting the KOSH - - - KATW flight plan from the specialized access list 404.

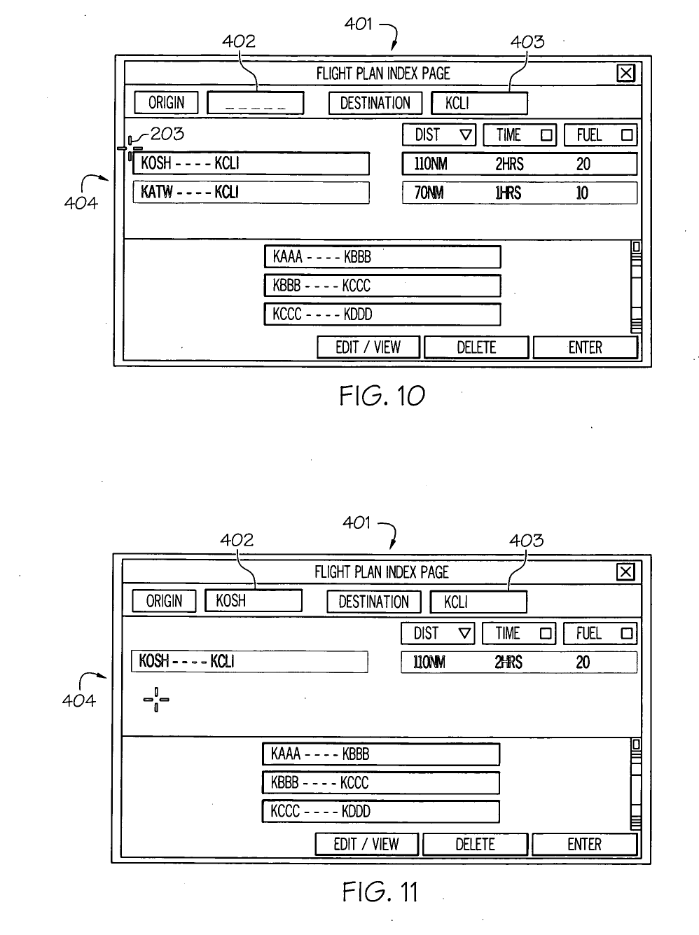

FIG. 10 illustrates the flight plan index page 401 after the operator has specified a destination (KCLI) in the destination text box 403, while the origin text box 402 remains unoccupied. Of particular interest is that the specialized access list 404 now includes only flight plans that have KCLI as the destination. The operator may then select a flight plan from the specialized access list 404, as described above. In the example shown in FIG. 10, the operator is selecting the KOSH - - - KCLI flight plan.

FIG. 11 illustrates the flight plan index page 401 after the operator has specified both an origin (KOSH) in the origin text box 402 and a destination (KCLI) in the destination text box 403. Of particular interest is that the specialized access list 404 now includes only flight plans that have KOSH as the origin and KCLI as the destination. The operator may then select a flight plan from the specialized access list 404, as described above. Although in the examples shown in FIG. 9-11 the custom flight plan list 405 is unaltered by the entry of the origin and/or destination, other embodiments may include the custom flight plan list 405 being filtered in a manner similar to the specialized access list 404.

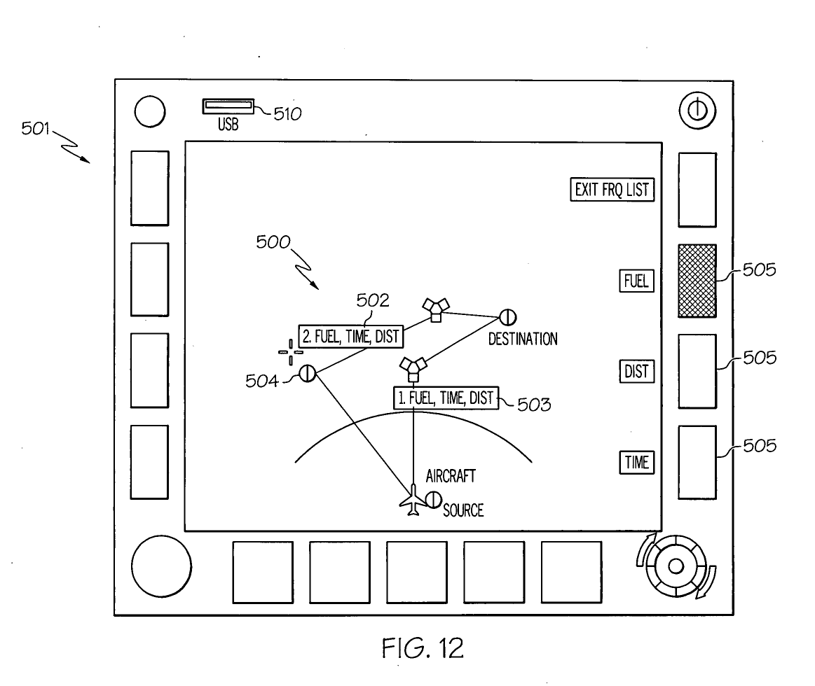

As shown in FIG. 12, in accordance with another aspect of the present invention, a navigational moving map 500 may be displayed on a FMS unit 501 (or a screen on the FMS unit) on which the flight plans from the specialized access list may be graphically displayed and prioritized. In one embodiment, the specialized access list is graphically displayed on the navigation map with various colors and/or numbering methods listing complete intermediate waypoints, and displaying fuel, distance and time requirements. In the depicted embodiment, two flight plans 502 and 503, along with waypoints 504, are displayed on the navigational moving map 500, as are the fuel, distance, and time requirements for each of the flight plans. The flight plans 502 and 503 have the same source and destination. The FMS unit 501 also includes functional keys 505 arranged about a periphery thereof, with associated key identifiers FUEL, DIST, and TIME being displayed on the screen. In one embodiment, the flight plans shown may be prioritized or sorted using the functional keys 505 (e.g., pressing the FUEL key causes the flight plans to be prioritized based on fuel consumption).

Still referring to FIG. 12 the FMS unit 501 also includes a Universal Serial Bus (USB) memory port 510. The processor 140 (FIG. 1) may execute a set of instructions to store the flown flight plan data in the navigational database 136. According to one aspect of the present invention, the operator then downloads the flown flight profiles onto a USB memory device (e.g., a ground-based computing system) through the USB memory port 510.

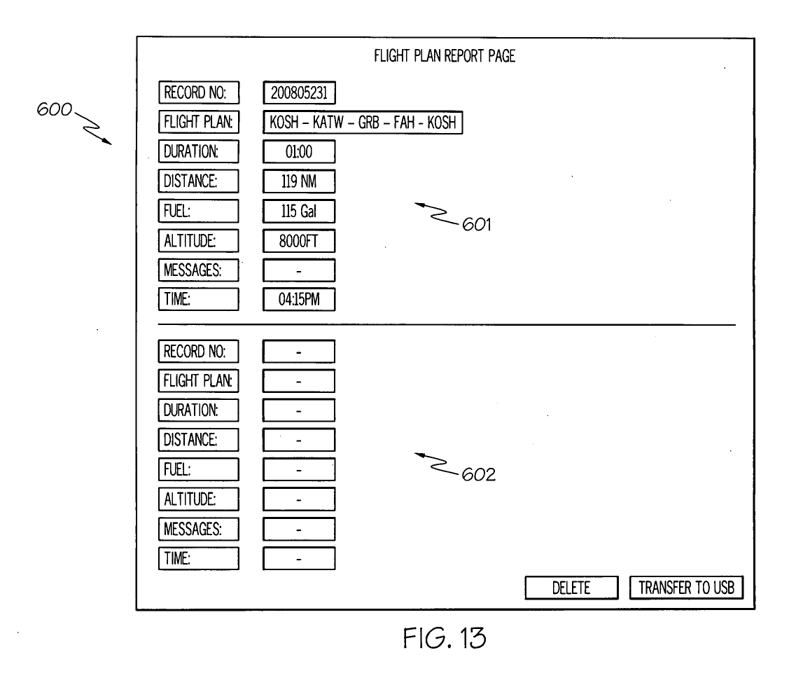

FIG. 13 illustrates a flight plan report window 600 in which is shown an exemplary format for storing and/or displaying the data of previously flown flight plans. In the depicted embodiment, a previously flown flight profile (and/or plan) 601 is displayed along with an empty flight profile 602, which may be entered for the next flight taken by the aircraft. The FMS unit 501 (and/or the processor 140) may generate the flight profiles in a particular file type, such as .txt or in a proprietary format, while an offline computer program may be used to interpret and analyze the data. Examples of data processing that may be performed include determining the total number of flights undertaken during a period of time (e.g., the previous month), total number of flight hours, total number of gallons of fuel consumed, fuel consumed on two different routes flown between a city, and critical messages generated on a flight and any diagnostic resulting.

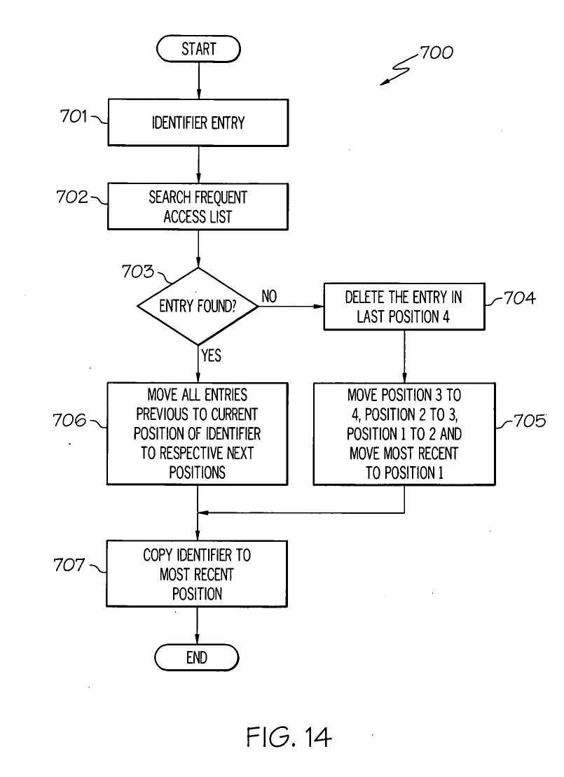

FIG. 14 illustrates a method 700 for generating and/or maintaining the specialized (or frequent) access list(s) described above according to one embodiment of the present invention. Although not specifically shown, for the purposes of this discussion, the specialized access list is assumed to have five entries (e.g., sources or destinations), a number that may be altered. Each of the five entries may be considered to occupy one of five positions in the list: most recent, position 1, position 2, position 3, and position 4. The method 700 begins at step 701 with the operator selecting a navigational identifier (e.g., a source or destination identifier), perhaps in a manner similar to those describes above. At step 702, the entered identifier is searched in the frequent access list. At step 703, a decision is made based on success or failure of the search. If the entered identifier is not on the list, the oldest entry from the list (i.e., that in position 4) is deleted at step 704. At step 705, all of the previous entries (i.e., those in the most recent position and positions 1-3), are each moved into the next position (e.g., the entry in the most recent position is moved into position 1). If the entered identifier is found in the list, at step 706 all of the entries with more recent positions on the list than that of the entered identifier are each moved into the next position. Regardless of whether or not the entered identifier is on the list, at step 707 the entered identifier is copied into the most recent position on the specialized access list.

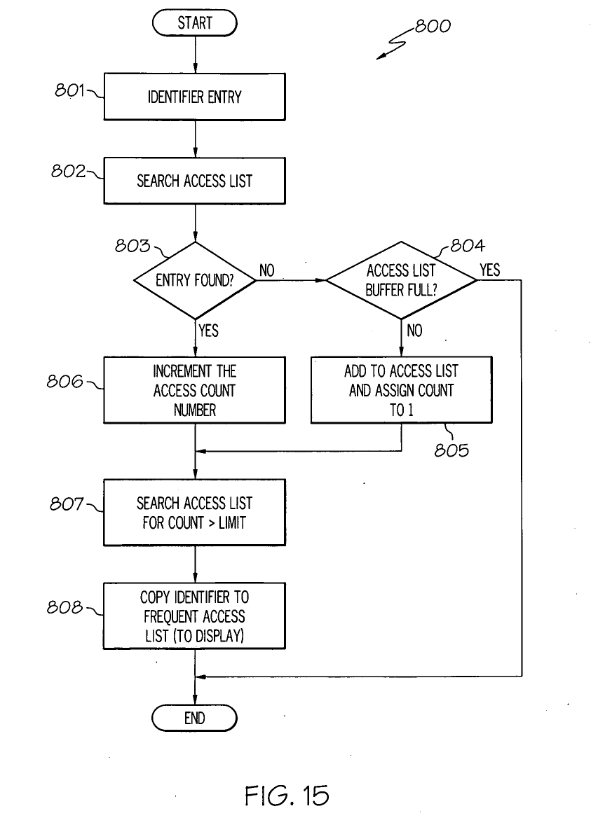

FIG. 15 illustrates a method 800 for generating and/or maintaining the specialized (or frequent) access list, according to another embodiment of the present invention. The method 800 begins at step 801 with the operator selecting a navigational identifier (e.g., a source or destination identifier), perhaps in a manner similar to those described above. At step 802, the entered identifier is searched in a complete access list (i.e., a list of all accessed identifiers along with a counter that stores number of accesses of each entry). At step 803, a decision is made based on success or failure of the search. If the entered identifier is not on the complete access list, at step 804 the available buffer space is checked for available space. If buffer space is available, the entered identifier is added to the complete access list and access count of the entered identifier is set to one. If no buffer space is available (i.e., the buffer is full), no action is taken and the method 800 ends.

If the entered identifier is on the complete access list, the method 800 proceeds to step 806, at which point the access count for the entered identifier is incremented by one. After both either step 805 or step 806, the method proceeds to step 807, at which point a search is made through complete access list for the identifiers which have been accessed (e.g., entered) a predetermined number of times (e.g., four times). At step 808 the identifiers that have been accessed at least the predetermined number of times are then displayed in the specialized access list.

One advantage of the method and system described above is that the total number of manual keystrokes, as well as the time required, required to enter navigational information is reduced. The present invention provides method and system for analyzing and deriving useful reports of historically flown flight plans. Also provided is a simple and intuitive user interface for the entry of flight plan data on aircraft flight management systems.

Although some of the embodiments described illustrate the invention being used with a graphical display, those of skill in the art will recognize that it is equally applicable to CDU or MCDU interfaces which are mainly text-based. Further, those of skill in the art will realize that while the various embodiments may be integrated into the same flight management system, each embodiment may work independently of the other embodiments disclosed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for managing flight plan data associated with an aircraft, the method comprising:
generating a list of navigational entry selections, each of the navigational entry selections being associated with the aircraft;
displaying the list of navigational entry selections to a user of the aircraft; and
receiving an indication of a selection of at least one of the navigational entry selections from the user of the aircraft.

2. The method of claim 1, wherein the generating the list of the navigational entry selections is based on previous navigational entries stored in a memory on-board the aircraft, a location of the aircraft, or a combination thereof.

3. The method of claim 2, wherein the navigational entry selections comprise origins of a flight plan, destinations of a flight plan, or a combination thereof.

4. The method of claim 3, further comprising generating a list a flight plan selections based on the at least one selected navigational entry.

5. The method of claim 4, further comprising displaying the list of fight plan selections to the user of the aircraft.

6. The method of claim 5, further comprising receiving an indication of a selection of one of the flight plan selections from the user.

7. The method of claim 4, wherein the generating the list of flight plan selections is further based on previous flight plans stored in the memory on-board the aircraft.

8. An avionics system comprising:
a display device;
a user input device in operable communication with the display device and configured to receive manual inputs from a user;
a memory device in operable communication with the display device and the user input device, the memory device being configured to store previous navigational entries associated with an aircraft; and
a processor in operable communication with the display device, the user input device, and the memory device, the processor configured to:
generate a list of navigational entry selections based on the previous navigational entries and a location of an aircraft;
display the list of navigational entry selections on the display device; and
select at least one of the navigational entry selections based on manual input received by the user input device.

9. The avionics system of claim 8, wherein the processor is further configured to store the previous navigational entries on the memory device based on previous manual user input received by the user input device before the generating of the list of navigational entry selections.

10. The avionics system of claim 9, further comprising a Global Positioning System (GPS) unit in operable communication with the processor, the GPS unit being configured to generate a signal representative of the location of the aircraft.

11. The avionics system of claim 10, wherein the navigational entry selections comprise origins of a flight plan, destinations of a flight plan, or a combination thereof.

12. The avionics system of claim 11, wherein the processor is further configured to generate a list a flight plan selections based on the at least one selected navigational entry.

13. The avionics system of claim 12, wherein the processor is further configured to display the list of fight plan selections on the display device.

14. The avionics system of claim 13, wherein the processor is further configured to select one of the flight plan selections from the user based on the manual input received by the user input device.

15. The avionics system of claim 14, wherein the user input device is a cursor control device (CCD).

16. A method for managing flight plan data associated with an aircraft, the method comprising:
storing flight plan data in a memory device on-board an aircraft;
transferring the stored flight plan data to a ground based computing system; and
performing an analysis on the flight plan data with the ground based computing system.

17. The method of claim 16, wherein the analysis comprises determining the total number of flights taken by the aircraft during a period of time, determining a total number of flight hours for the aircraft, determining a total number of gallons of fuel consumed by the aircraft, determining fuel consumption for selected flight plans, determining critical messages generated, or a combination thereof.

18. The method of claim 16, further comprising:
generating a list of navigational entry selections, each of the navigational entries being associated with the flight plan data;
displaying the list of navigational entry selections to a user of the aircraft; and
receiving an indication of a selection of at least one of the navigational entry selections from the user.

19. The method of claim 18, wherein the generating the list of the navigational entry selections is based on previous navigational entries stored in the memory on-board the aircraft, a location of the aircraft, or a combination thereof.

20. The method of claim 19, wherein the navigational entry selections comprise origins of a flight plan, destinations of a flight plan, or a combination thereof.
